(19) United States
(12) Patent Application Publication
(10) Pub. No.: US 2026/0184142 A1
(43) Pub. Date: Jul. 2, 2026

(54) AUTOMOBILE SUNSHADE

(71) Applicant: Libo Jin, Shenzhen (CN)

(72) Inventor: Libo Jin, Shenzhen (CN)

(21) Appl. No.: 19/551,795

(22) Filed: Feb. 27, 2026

(30) Foreign Application Priority Data
Feb. 5, 2026 (CN) 202610168398.2

(51) Int. Cl. B60J 1/20; B32B 3/10; B32B 5/02; B32B 27/08; B32B 27/32

(52) U.S. Cl. CPC B60J 1/2011; B32B 3/10; B32B 5/022; B32B 27/08; B32B 27/32; B32B 2250/05; B32B 2250/242; B32B 2255/02; B32B 2605/00

(57) ABSTRACT

The present application relates to the technical field of daily necessities, and discloses an automobile sunshade, which includes a non-woven fabric, a PE plastic film layer, a PE bubble layer and a film coating layer, wherein a first surface of the non-woven fabric is printed with a pattern, the non-woven fabric is located at an outermost side of an automobile sunshade, the PE plastic film layer is provided with at least one layer, wherein one layer of the PE plastic film layer is located at an innermost side of the automobile sunshade, the PE plastic film layer is composed of a PE plastic film, the PE bubble layer is provided with at least one layer, the PE bubble layer is used for connecting two adjacent PE plastic film layers or connecting an adjacent film coating layer and the PE plastic film layer.

### TECHNICAL FIELD

The present disclosure belongs to the technical field of daily necessities, and more particularly relates to an automobile sunshade.

### BACKGROUND ART

In order to avoid direct sunlight to the interior instrument desk, steering wheel and other parts, and at the same time reduce the interior temperature, there are a variety of automobile sunshade tools in the market, especially the automobile sunshade is common. At present, a PE bubble film is generally used as the main material for the automobile sunshade. When printing pattern for automobile sunshade, it is necessary to first print on a layer of OPP plastic film, then compound the layer of OPP film with PE film, and finally composite with PE bubble layer. As shown in FIG. 1 and FIG. 2, it is difficult to directly print pattern on the OPP plastic film or the PE film by digital printing process. For example, the Chinese Patent Publication No. CN102717684A discloses that a high-strength heat-insulating sunshade includes, in order from top to bottom, a OPP printing film, a PE layer, a first kraft paper layer, a first glue layer, a second kraft paper layer, a second glue layer and a PET aluminium-plated film.

The automobile sunshade with this structure needs a high cost and a long period to open pattern printing template, and has to go through many times of compounding, and the production is relatively complex, which is only suitable for production in the case of a high order quantity. Furthermore, since the pattern is printed on the OPP plastic film, the automobile sunshade can only print the “vector” image, the number and type of the pattern are relatively small, and the clarity and fidelity of the pattern are relatively poor as shown in FIG. 3, which is difficult to meet the requirements of the market and consumers for the quality of the pattern.

### SUMMARY OF THE INVENTION

An object of the present disclosure is to solve at least one of the problems of the prior art, and to provide an automobile sunshade.

In order to achieve the above-mentioned object, the present disclosure provides an automobile sunshade, which includes a non-woven fabric, a PE plastic film layer, a PE bubble layer and a film coating layer, wherein a first surface of the non-woven fabric is printed with a pattern, the non-woven fabric is located at an outermost side of an automobile sunshade, the PE plastic film layer is provided with at least one layer, wherein one layer of the PE plastic film layer is located at an innermost side of the automobile sunshade, the PE plastic film layer is composed of a PE plastic film, the PE bubble layer is provided with at least one layer, the PE bubble layer is used for connecting two adjacent PE plastic film layers or connecting an adjacent film coating layer and the PE plastic film layer, and the film coating layer is used for connecting a second surface of the non-woven fabric and the PE bubble layer closest to the non-woven fabric.

As an alternative embodiment, the pattern is printed on the first surface of the non-woven fabric by a digital printing process.

As an alternative embodiment, the pattern is printed on the thermal transfer paper by a digital printing process, and then the pattern of the thermal transfer paper is thermally transferred to the first surface of the non-woven fabric by a thermal transfer process.

As an alternative embodiment, the PE plastic film layer and the PE bubble layer are both provided with a single layer, and the automobile sunshade is formed by connecting the non-woven fabric, the film coating layer, the PE bubble layer and the PE plastic film layer in sequence from the outside to the inside.

As an alternative embodiment, the PE bubble layer is provided with two layers, and is respectively a first PE bubble layer and a second PE bubble layer; the PE plastic film layer is provided with three layers, and is respectively a first PE plastic film layer, a second PE plastic film layer and a third PE plastic film layer; and the automobile sunshade is formed by connecting the non-woven fabric, the film coating layer, the first PE bubble layer, the first PE plastic film layer, the second PE plastic film layer, the second PE bubble layer and the third PE plastic film layer in sequence from the outside to the inside.

As an alternative embodiment, the PE bubble layer is provided with two layers, and is respectively a first PE bubble layer and a second PE bubble layer; the PE plastic film layer is provided with two layers, and is respectively a first PE plastic film layer and a second PE plastic film layer; and the automobile sunshade is formed by connecting the non-woven fabric, the film coating layer, the first PE bubble layer, the first PE plastic film layer, the second PE bubble layer and the second PE plastic film layer in sequence from the outside to the inside.

As an alternative embodiment, the PE bubble layer is connected to an adjacent PE plastic film layer or the film coating layer by hot pressing.

As an alternative embodiment, the first surface of the non-woven fabric is provided with a protective layer, and the protective layer covers the pattern.

As an alternative embodiment, the film coating layer, the second surface of the non-woven fabric and the PE bubble layer closest to the non-woven fabric are connected by hot pressing.

As an alternative embodiment, the film coating layer is made of EC7A PE film coating material. In order to improve the performance of the film coating layer, EC7A PE film coating material may also be mixed with functional processing aids such as plasticizers, reinforcing agents and stabilizers to form a film coating layer, so that the film coating layer has good properties such as good heat sealability, uniformity, impact strength and stability.

Advantageous Effects of the present disclosure: in the present disclosure, a non-woven fabric, a film coating layer, a PE bubble layer and a PE film layer are bonded to each other by hot pressing to form an automobile sunshade, and the bonding of the non-woven fabric and the PE bubble layer enables a digital printing process to be used to print a diversified pattern when printing the pattern of the automobile sunshade, without the need to expensively open a printing template, and the production cycle of the automobile sunshade can be reduced in a small batch production, and the printed pattern of the automobile sunshade achieves a high-definition and high-fidelity effect, which can better meet the application requirements of the market and consumers.

The features and advantages of the present disclosure will be described in detail by way of example with reference to the accompanying drawings.

### BRIEF DESCRIPTION OF THE DRAWINGS

FIG. 1 is a structural schematic view of an existing single layer PE bubble layer structure of an automobile sunshade.

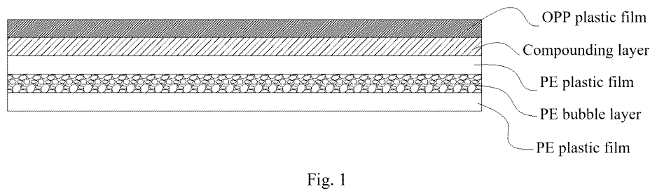

FIG. 2 is a structural schematic view of an existing double layer PE bubble layer structure of an automobile sunshade.

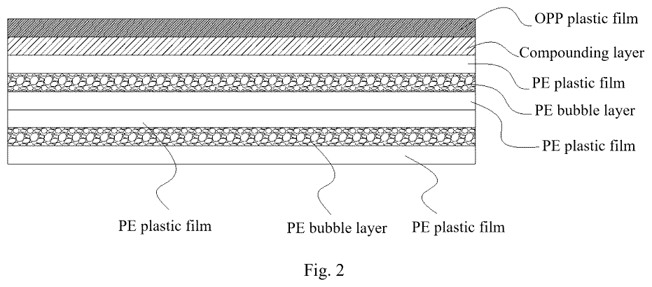

FIG. 3 is a schematic view showing a pattern printing effect of an existing automobile sunshade.

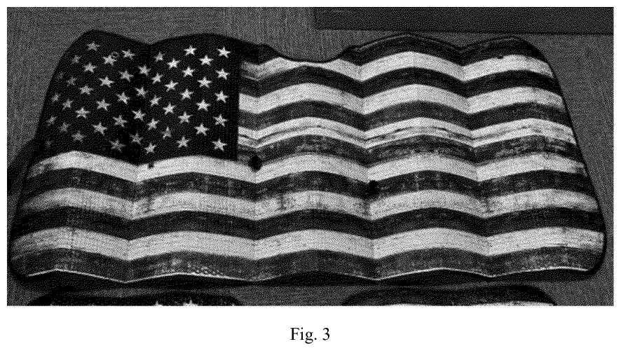

FIG. 4 is a structural schematic view of a single layer PE bubble layer structure of an automobile sunshade according to an example of the present disclosure.

FIG. 5 is a structural schematic view of a double layer PE bubble layer structure of automobile sunshade according to an example of the present disclosure.

FIG. 6 is another structural schematic view of a double layer PE bubble layer structure of automobile sunshade according to an example of the present disclosure.

FIG. 7 is a schematic view showing a pattern printing effect of an automobile sunshade according to an example of the present disclosure.

FIG. 8 is a structural schematic view of a single layer PE bubble layer and a protective layer structure of an automobile sunshade according to an example of the present disclosure.

FIG. 9 is a structural schematic view of a double layer PE bubble layer and a protective layer structure of automobile sunshade according to an example of the present disclosure.

FIG. 10 is another structural schematic view of a double layer PE bubble layer and a protective layer structure of automobile sunshade according to an example of the present disclosure.

In the figures: 1. non-woven fabric; 2. film coating layer; 3. PE bubble layer; 4. PE plastic film layer; and 5. protective layer.

### DETAILED DESCRIPTION OF THE INVENTION

In order to make the objectives, technical solutions, and advantages of the examples of the present application clearer, the technical solutions in the examples of the present application will be described clearly and completely below in conjunction with the accompanying drawings of the examples of the present application. The described examples are some, but not all examples of the present application. The components of the examples of the present application, which are generally described and illustrated in the drawings herein, may be arranged and designed in a wide variety of different configurations. In the description of the present application, it should be noted that the directional or positional relationship indicated by the terms “inner”, “outer”, and the like, is based on the orientation or positional relationship shown in the drawings, or the orientation or positional relationship which is typical in the use of the article of the present application, and is intended merely to facilitate and simplify the description of the present application, rather than to indicate or imply that the apparatus or element being referred to must have a particular orientation, be constructed and operated in a particular orientation, and should not be construed as limiting the application. Furthermore, the terms “first”, “second”, and the like are used for descriptive distinction only and are not to be construed as indicating or implying relative importance.

In the description of the present application, it should also be noted that, unless expressly specified and limited otherwise, the terms “disposed” and “connected” are to be interpreted broadly, e.g. as a fixed connection, as a detachable connection, or as an integral connection; it may be directly connected or indirectly connected through an intermediate medium, and it may be the internal communication between two elements. The specific meaning of the above terms in the present application will be understood by those skilled in the art on a case-by-case basis.

Hereinafter, the present disclosure will be described in detail with reference to the accompanying drawings.

### Example 1

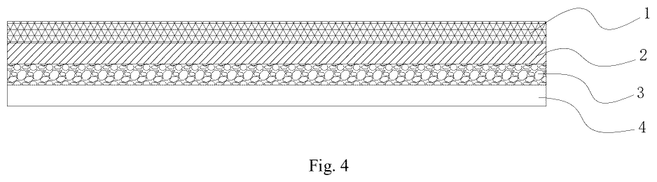

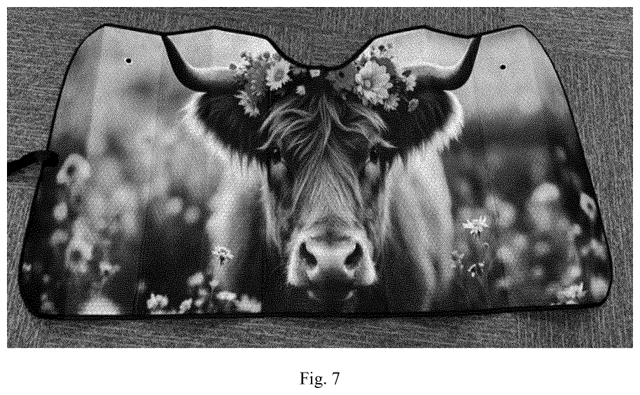

With reference to FIGS. 4 and 7, the Example 1 provides an automobile sunshade, and the automobile sunshade is successively connected from the outside to the inside by a non-woven fabric 1, a film coating layer 2, a PE bubble layer 3 and a PE plastic film layer 4 by hot pressing; a pattern is printed on a first surface of the non-woven fabric 1, and a first surface of the non-woven fabric 1 is the surface of the non-woven fabric 1 at one end away from the PE bubble layer 3.

As an embodiment of the printed pattern of the non-woven fabric of the Example 1, a pattern is printed on the first surface of the non-woven fabric 1 by a digital printing process. The pattern may be a planar pattern or a three-dimensional pattern. The pattern may be a single color pattern or may be a mixed color pattern.

As another embodiment of the printed pattern of the non-woven fabric of the Example 1, a pattern is printed on a thermal transfer paper by a digital printing process, and then the pattern of the thermal transfer paper is thermally transferred to the first surface of the non-woven fabric 1 by a thermal transfer process.

### Example 2

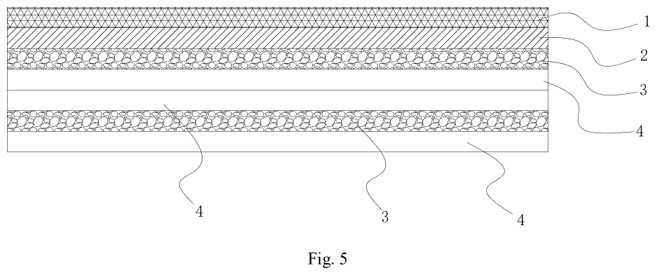

With reference to FIGS. 5 and 7, the Example 2 provides an automobile sunshade, which includes a non-woven fabric 1, a PE plastic film layer 4, a PE bubble layer 3 and a film coating layer 2, wherein the PE bubble layer 3 is provided with two layers and is respectively a first PE bubble layer and a second PE bubble layer, and the PE plastic film layer 4 is provided with three layers and is respectively a first PE plastic film layer, a second PE plastic film layer and a third PE plastic film layer. An automobile sunshade is formed by connecting a non-woven fabric 1, a film coating layer 2, a first PE bubble layer, a first PE plastic film layer, a second PE plastic film layer, a second PE bubble layer and a third PE plastic film layer in sequence from the outside to the inside by hot pressing. A first surface of the non-woven fabric 1 is printed with a pattern, and the first surface of the non-woven fabric 1 is a surface of the non-woven fabric 1 at one end away from the first PE bubble layer.

The thickness of the first PE plastic film layer, the second PE plastic film layer and the third PE plastic film layer, and the thickness of the first PE bubble layer and the second PE bubble layer can all be the same or different, and can be set according to the preparation requirements of the automobile sunshade.

As an embodiment of the printed pattern of the non-woven fabric of the Example 2, a pattern is printed on the first surface of the non-woven fabric 1 by a digital printing process. The pattern may be a planar pattern or a three-dimensional pattern. The pattern may be a single color pattern or may be a mixed color pattern.

As another embodiment of the printed pattern of the non-woven fabric of the Example 2, a pattern is printed on a thermal transfer paper by a digital printing process, and then the pattern of the thermal transfer paper is thermally transferred to the first surface of the non-woven fabric 1 by a thermal transfer process.

### Example 3

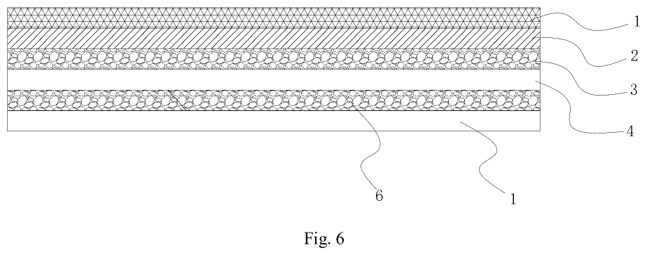

With reference to FIGS. 6 and 7, the Example 3 provides an automobile sunshade, which includes a non-woven fabric 1, a PE plastic film layer 4, a PE bubble layer 3 and a film coating layer 2, wherein the PE bubble layer 3 is provided with two layers and is respectively a first PE bubble layer and a second PE bubble layer, the PE plastic film layer is provided with two layers and is respectively a first PE plastic film layer and a second PE plastic film layer, and the automobile sunshade is formed by connecting the non-woven fabric 1, the film coating layer 2, the first PE bubble layer, the first PE plastic film layer, the second PE bubble layer and the second PE plastic film layer in sequence from the outside to the inside by hot pressing. A first surface of the non-woven fabric 1 is printed with a pattern, and the first surface of the non-woven fabric 1 is a surface of the non-woven fabric at one end away from the first PE bubble layer.

The thickness of the first PE plastic film layer and the second PE plastic film layer, and the thickness of the first PE bubble layer and the second PE bubble layer can all be the same or different, and can be set according to the preparation requirements of the automobile sunshade.

As an embodiment of the printed pattern of the non-woven fabric of the Example 3, a pattern is printed on the first surface of the non-woven fabric 1 by a digital printing process. The pattern may be a planar pattern or a three-dimensional pattern. The pattern may be a single color pattern or may be a mixed color pattern.

As another embodiment of the printed pattern of the non-woven fabric of the Example 3, a pattern is printed on a thermal transfer paper by a digital printing process, and then the pattern of the thermal transfer paper is thermally transferred to the first surface of the non-woven fabric 1 by a thermal transfer process.

### Example 4

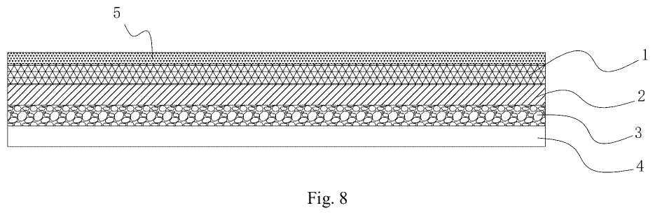

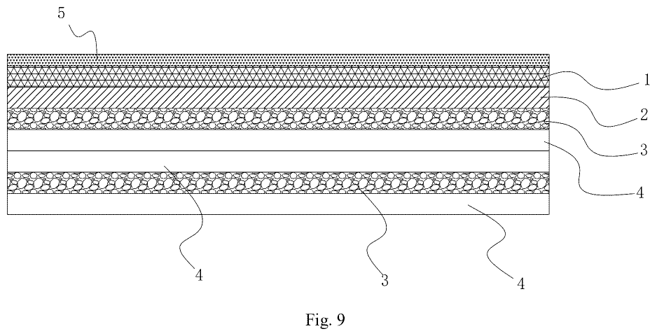

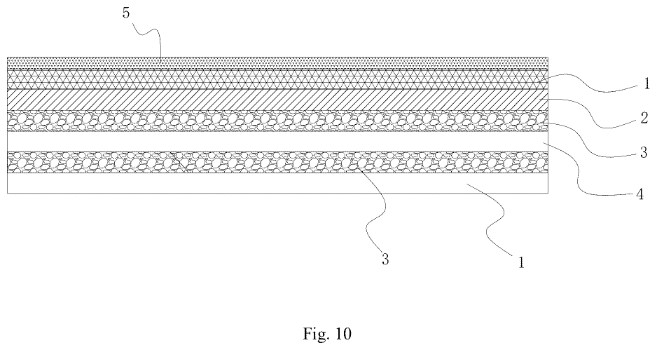

Referring to FIGS. 7 to 10, the Example 4 provides an automobile sunshade having a structure in which a protective layer 5 is provided on a first surface of a non-woven fabric 1 on the basis of any of the Example 1 to the Example 3, and the protective layer 5 covers a pattern.

The protective layer 5 is bonded to the non-woven fabric 1 by coating or hot pressing, and the protective layer 5 can be made of an aliphatic polyurethane coating layer or an acrylic resin coating layer or a PVC transparent film or a PET transparent film. The provision of the protective layer 5 enables the automobile sunshade to satisfy the requirements of transparency, waterproofness, corrosion resistance, wear resistance, etc. and to take into account the requirements of touch, safety (matte) and environmental protection.

In the above-mentioned Examples 1, 2, 3 and 4, the film coating layers are all made of EC7A PE film coating materials, and other film coating materials containing PE materials of different types, such as metallocene PE film coating materials, can also be used. Plasticizers, reinforcing agents, stabilizers, and other functional processing aids can also be added to the film coating material in order to improve the performance of the sunshade. The PE plastic film layer is made of a PE film, and the PE film may be any one of an aluminized PE film or a white/black PE film or a PET/PE composite film or an NY/PE composite film. The PE bubble Layer is made of a PE bubble film.

In the above-mentioned Examples 1, 2, 3 and 4, in the manufacturing process, the film coating layer is formed on the second surface of the non-woven fabric (an end surface opposite to the first surface) with a PE film coating layer of about 20 μm to 30 μm by using a PE film coating treatment, and the first surface of the non-woven fabric is printed with a target pattern by using a single digital printing process or a digital printing process and a thermal transfer process; the printed non-woven fabric and the PE film coating layer, the PE bubble layer and the PE plastic film layer are bonded together by hot pressing with a hot press machine to obtain a composite sheet, wherein the hot pressing bonding is performed under the conditions of a temperature of 110° C. to 130° C., a pressure of 8 kg/cm2 to 15 kg/cm2, and a pressure-holding time of 30 s to 90 s; and the film coating layer, the PE bubble layer and the PE plastic film layer of the front sunshade can be bonded by hot pressing to be preheated to 90° C. to 110° C. so as to reduce the temperature difference with the hot pressing plate of the hot press machine and promote uniform connection, and after the hot pressing bonding, cooling and solidifying are performed, and finally a complete sunshade is obtained by cutting and edge wrapping.

In the manufacturing process, the hot press machine adopts a multi-layer flat plate hot press machine or a hot roller compounding machine, and in the hot pressing process, the PE molecular chain segments at the contact surfaces of each layer of the film coating layer, the PE bubble layer and the PE plastic film layer of the sunshade are inter-diffused, wound and cooled to form a firm welding interface; using a large-scale flat plate die cutting machine or a numerical control cutting machine to cut the composite large sheet into the shape of a single sunshade (such as an oval shape and a rectangular shape with an arc angle); using an ultrasonic welding or a high-frequency heat sealing machine to fix the webbing or the elastic edge wrapping strip on the edge of the sunshade; there is no need to apply an additional adhesive during the preparation of the sunshade.

In order to facilitate the attachment of the sunshade to the vehicle window, the automobile sunshade of each of the above-described examples may be provided with a suction structure or a strap structure, including but not limited to a suction cup.

The above-described examples are illustrative of the present disclosure and are not to be construed as limiting thereof, and any variations of the present disclosure are intended to be within the scope of the present disclosure.

1. An automobile sunshade, comprising a non-woven fabric, a PE plastic film layer, a PE bubble layer and a film coating layer, wherein a first surface of the non-woven fabric is printed with a pattern, the non-woven fabric is located at an outermost side of an automobile sunshade, the PE plastic film layer is provided with at least one layer, wherein one layer of the PE plastic film layer is located at an innermost side of the automobile sunshade, the PE plastic film layer is composed of a PE plastic film, the PE bubble layer is provided with at least one layer, the PE bubble layer is used for connecting two adjacent PE plastic film layers or connecting an adjacent film coating layer and the PE plastic film layer, and the film coating layer is used for connecting a second surface of the non-woven fabric and the PE bubble layer closest to the non-woven fabric.

2. The automobile sunshade according to claim 1, wherein the pattern is printed on the first surface of the non-woven fabric by a digital printing process.

3. The automobile sunshade according to claim 1, wherein the pattern is first printed on a thermal transfer paper by a digital printing process, and then the pattern of the thermal transfer paper is thermally transferred to the first surface of the non-woven fabric by a thermal transfer process.

4. The automobile sunshade according to claim 1, wherein the PE plastic film layer and the PE bubble layer are both provided with a single layer, and the automobile sunshade is formed by connecting the non-woven fabric, the film coating layer, the PE bubble layer and the PE plastic film layer in sequence from the outside to the inside.

5. The automobile sunshade according to claim 1, wherein the PE bubble layer is provided with two layers, and is respectively a first PE bubble layer and a second PE bubble layer; the PE plastic film layer is provided with three layers, and is respectively a first PE plastic film layer, a second PE plastic film layer and a third PE plastic film layer; and the automobile sunshade is formed by connecting the non-woven fabric, the film coating layer, the first PE bubble layer, the first PE plastic film layer, the second PE plastic film layer, the second PE bubble layer and the third PE plastic film layer in sequence from the outside to the inside.

6. The automobile sunshade according to claim 1, wherein the PE bubble layer is provided with two layers, and is respectively a first PE bubble layer and a second PE bubble layer; the PE plastic film layer is provided with two layers, and is respectively a first PE plastic film layer and a second PE plastic film layer; and the automobile sunshade is formed by connecting the non-woven fabric, the film coating layer, the first PE bubble layer, the first PE plastic film layer, the second PE bubble layer and the second PE plastic film layer in sequence from the outside to the inside.

7. The automobile sunshade according to claim 1, wherein the PE bubble layer is connected to an adjacent PE plastic film layer or the film coating layer by hot pressing.

8. The automobile sunshade according to claim 1, wherein the first surface of the non-woven fabric is provided with a protective layer, and the protective layer covers the pattern.

9. The automobile sunshade according to claim 1, wherein the film coating layer, the second surface of the non-woven fabric and the PE bubble layer closest to the non-woven fabric are connected by hot pressing.

10. The automobile sunshade according to claim 1, wherein the film coating layer is made of EC7A PE film coating material.
